(19) United States
(12) Patent Application Publication
(10) Pub. No.: US 2026/0217227 A1
(43) Pub. Date: Jul. 30, 2026

(54) CONTROL DEVICE, OFF-ROAD VEHICLE, AND CONTROL METHOD

(71) Applicant: Robert Bosch GmbH, Stuttgart (DE)

(72) Inventor: Daisuke Sakata, Kanagawa (JP)

(21) Appl. No.: 19/149,228

(22) PCT Filed: Jan. 18, 2024
(86) PCT No.: PCT/IB2024/050472

§ 371 Date: Jul. 18, 2025

(30) Foreign Application Priority Data
Jan. 26, 2023 (JP) 2023-010568

(51) Int. Cl. B60T 7/12

(52) U.S. Cl. CPC B60T 7/12; B60T 2201/04; B60T 2210/16; B60T 2210/30; B60T 2250/00; B60T 2250/04

(57) ABSTRACT

To obtain a control device for an off-road vehicle capable of allowing a driver to concentrate on a steering operation when an off-road vehicle stops forward movement on an uphill road surface and temporarily moves backward.

A control device for an off-road vehicle according to the present invention includes: an acquisition section that acquires traveling state information of the off-road vehicle including vehicle speed information and traveling direction information; a target vehicle speed selection section that selects a forward target vehicle speed when moving the off-road vehicle forward and a backward target vehicle speed when moving the off-road vehicle backward as the target vehicle speed of the off-road vehicle on the basis of the traveling direction information acquired by the acquisition section; and an execution section that controls a braking force generated in a wheel in response to the vehicle speed information acquired by the acquisition section and the target vehicle speed selected by the target vehicle speed selection section while an accelerator of the off-road vehicle is not operated and executes hill descent control.

### BACKGROUND

The present invention relates to a control device for executing hill descent control of an off-road vehicle, an off-road vehicle equipped with the control device, and a control method of executing hill descent control of an off-road vehicle.

Among conventional vehicles, there is known one equipped with a control device for executing hill descent control (see JP2020-12434A). In the hill descent control, the control device controls a braking force generated in a wheel so that a vehicle speed becomes a target vehicle speed when the vehicle speed exceeds the target vehicle speed (or when the vehicle speed is about to exceed the target vehicle speed) during forward movement of a vehicle on a downhill road surface in a non-operation state of an accelerator. Accordingly, when the vehicle moves forward on the downhill road surface, the vehicle can move forward on the downhill road surface at a vehicle speed close to a target vehicle speed even when a driver does not operate an accelerator and a brake.

### SUMMARY

An off-road vehicle (a vehicle which is good at traveling on a road surface other than a paved road) exists as a type of vehicle. The conventional off-road vehicle is also expected to be equipped with a control device that executes the hill descent control. Here, since the off-road vehicle may travel on a road surface with poor road surface conditions, the off-road vehicle may not be able to climb an uphill road surface when attempting to climb the road surface. In such a case, the driver operates the brake to stop the off-road vehicle. Then, the driver gradually reduces the braking force generated in the wheel by operating the brake and temporarily moves the off-road vehicle backward.

When the off-road vehicle stops forward movement on the uphill road surface and temporarily moves backward, the driver moves the off-road vehicle backward while operating the brake if the hill descent control is not executed. Further, if the hill descent control is executed regardless of determining the vehicle traveling direction when the off-road vehicle stops the forward movement on the uphill road surface and temporarily moves backward, the braking force generated in the wheel is controlled so that the target vehicle speed is the same as when moving forward on the downhill road surface. However, a situation of maneuvering when moving the off-road vehicle backward is different from that of maneuvering when moving the off-road vehicle forward. Therefore, even when the hill descent control is executed at the same target vehicle speed as when moving forward on the downhill road surface when the off-road vehicle stops the forward movement on the uphill road surface and temporarily moves backward, the vehicle speed may make the driver feel uncomfortable.

The present invention has been made in view of the above-described problems and a first object thereof is to obtain a control device for executing hill descent control of an off-road vehicle and allowing a driver to concentrate on a steering operation when an off-road vehicle stops forward movement on an uphill road surface and temporarily moves backward. Further, a second object of the present invention is to obtain an off-road vehicle equipped with such a control device. Further, a third object of the present invention is to obtain a control method of executing hill descent control of an off-road vehicle and allowing a driver to concentrate on a steering operation when an off-road vehicle stops forward movement on an uphill road surface and temporarily moves backward.

A control device according to the present invention is a control device for controlling a braking force generated in a wheel of an off-road vehicle and executing hill descent control, the control device including: an acquisition section that acquires traveling state information of the off-road vehicle including vehicle speed information and traveling direction information; a target vehicle speed selection section that stores a forward target vehicle speed which is a target vehicle speed when moving the off-road vehicle forward and a backward target vehicle speed which is a target vehicle speed when moving the off-road vehicle backward and selects the forward target vehicle speed when moving the off-road vehicle forward and the backward target vehicle speed when moving the off-road vehicle backward as the target vehicle speed of the off-road vehicle on the basis of the traveling direction information acquired by the acquisition section; and an execution section that controls the braking force in response to the vehicle speed information acquired by the acquisition section and the target vehicle speed selected by the target vehicle speed selection section while an accelerator of the off-road vehicle is not operated and executes the hill descent control.

Further, an off-road vehicle according to the present invention includes the control device according to the present invention.

Further, a control method according to the present invention is a control method of controlling a braking force generated in a wheel of an off-road vehicle and executing hill descent control, the control method including: an acquisition step of acquiring traveling state information of the off-road vehicle including vehicle speed information and traveling direction information; a target vehicle speed selection step of selecting a forward target vehicle speed when moving the off-road vehicle forward and a backward target vehicle speed when moving the off-road vehicle backward as the target vehicle speed of the off-road vehicle on the basis of the traveling direction information acquired by the acquisition step; and an execution step of controlling the braking force in response to the vehicle speed information acquired by the acquisition step and the target vehicle speed selected by the target vehicle speed selection step while an accelerator of the off-road vehicle is not operated and executing the hill descent control.

In the hill descent control which is executed by the present invention, the target vehicle speed is set independently when moving the off-road vehicle forward and backward. Therefore, in the off-road vehicle adopting the present invention, the hill descent control can be executed by using a suitable target vehicle speed when the off-road vehicle stops the forward movement on the uphill road surface and temporarily moves backward. Thus, the present invention allows the driver to concentrate on the steering operation when the off-road vehicle stops the forward movement on the uphill road surface and temporarily moves backward.

### BRIEF DESCRIPTION OF DRAWINGS

FIG. 1 is a side view of an off-road vehicle equipped with a control device according to an embodiment of the present invention.

FIG. 2 is a block diagram showing the control device according to the embodiment of the present invention.

FIG. 3 is a diagram illustrating an example of a traveling situation of an off-road vehicle 100 according to the embodiment of the present invention.

FIG. 4 is a diagram illustrating another example of the traveling situation of the off-road vehicle 100 according to the embodiment of the present invention.

FIG. 5 is a flowchart showing a control method when the control device according to the embodiment of the present invention executes hill descent control.

FIG. 6 is a side view of an off-road vehicle equipped with a modified example of the control device according to the embodiment of the present invention.

FIG. 7 is a block diagram showing a modified example of the control device according to the embodiment of the present invention.

### DETAILED DESCRIPTION

Hereinafter, an example of a control device, an off-road vehicle, and a control method according to the present invention will be described with reference to the drawings.

Furthermore, although a four-wheeled motor vehicle will be described below as an example of an off-road vehicle adopting the present invention, the off-road vehicle adopting the present invention may be an off-road vehicle other than the four-wheeled motor vehicle. Examples of the off-road vehicles other than the four-wheeled motor vehicles include bicycles and the like in addition to motorcycles and tricycles whose driving source is at least one of an engine and an electric motor. Furthermore, bicycles refer to any vehicle that can be propelled on the road by the tread force applied to the pedals. That is, bicycles include regular bicycles, electrically assisted bicycles, electric bicycles, and the like.

Further, the configuration and operation described below are merely examples, and the present invention is not limited to such configuration and operation. Further, in each figure, the same or similar members or parts may be indicated by the same reference numerals or may be omitted. Further, detailed structures are simplified or omitted as appropriate.

### Embodiment

Hereinafter, a control device according to this embodiment, an off-road vehicle equipped with the control device, and a control method according to this embodiment will be described.

### <Configuration of Off-Road Vehicle and Control Device>

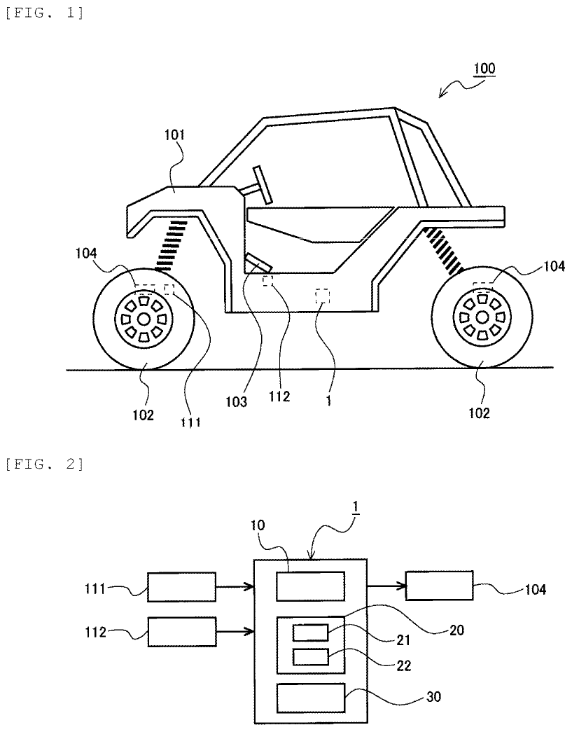

FIG. 1 is a side view of an off-road vehicle equipped with a control device according to the embodiment of the present invention. Furthermore, in FIG. 1, the left side of the paper is the front side of an off-road vehicle 100. That is, FIG. 1 shows the off-road vehicle 100 when viewed from the left side.

The off-road vehicle 100 includes a vehicle body 101 and a wheel 102 rotatably connected to the vehicle body 101. Since the off-road vehicle 100 according to this embodiment is a four-wheeled motor vehicle, four wheels 102 are provided. Specifically, the off-road vehicle 100 includes a left front wheel, a right front wheel, a left rear wheel, and a right rear wheel as the wheels 102. These wheels 102 are rotatably connected to the vehicle body 101 by suspensions and the like. Furthermore, in FIG. 1 showing the off-road vehicle 100 from the left side, the left front wheel and the left rear wheel are shown among the four wheels 102.

This off-road vehicle 100 includes a control device 1 which controls a braking force generated in the wheels 102 and executes hill descent control. That is, the control device 1 controls a braking device 104 of a braking system of the off-road vehicle 100 and executes the hill descent control. The control device 1 may be a single device or divided into a plurality of devices. Further, a part or all of the control device 1 may be configured by, for example, a microcomputer, a microprocessor unit, and the like, may be configured by something that can be updated such as firmware, and may be configured by a program module and the like executed by instructions from a CPU and the like.

Furthermore, the braking system of the off-road vehicle 100 according to this embodiment is configured to control the hydraulic pressure of brake fluid and control the braking force generated in the wheels 102. However, the braking system of the off-road vehicle 100 according to this embodiment is not limited to one configured to control the hydraulic pressure of brake fluid. Conventionally, various braking systems have been proposed as braking systems for off-road vehicles, such as braking systems using brake wires. The braking system of the off-road vehicle 100 according to this embodiment may adopt any one of these braking systems.

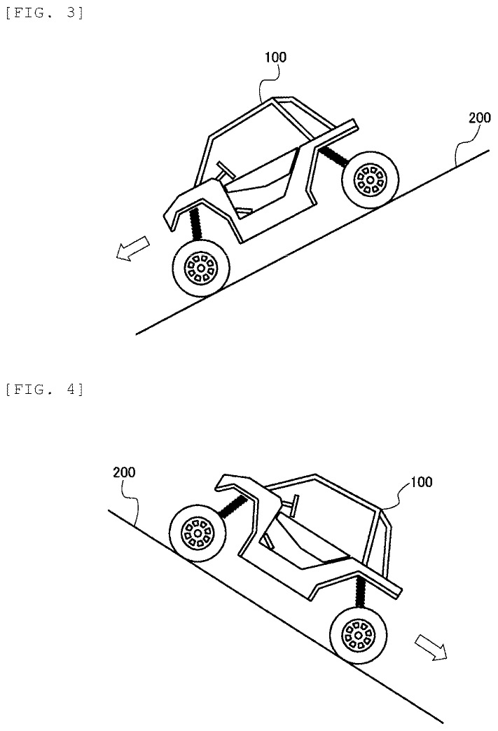

FIG. 2 is a block diagram showing the control device according to the embodiment of the present invention.

The control device 1 includes an acquisition section 10, a target vehicle speed selection section 20, and an execution section 30 as functional sections.

The acquisition section 10 is a functional section which acquires traveling state information of the off-road vehicle 100. The traveling state information acquired by the acquisition section 10 includes at least vehicle speed information and traveling direction information of the off-road vehicle 100.

Specifically, in this embodiment, as shown in FIG. 1, the off-road vehicle 100 includes a wheel speed sensor 111 which detects the rotation speed of the wheel 102. Then, the acquisition section 10 acquires the vehicle speed of the off-road vehicle 100 as the vehicle speed information on the basis of the rotation speed of the wheel 102 detected by the wheel speed sensor 111. Furthermore, the acquisition section 10 may acquire the vehicle speed information from a source other than the wheel speed sensor 111. Further, the acquisition section 10 may acquire information for acquiring the vehicle speed information from a source other than the wheel speed sensor 111. Further, the acquisition section 10 may acquire a physical quantity other than the vehicle speed that can be converted into the vehicle speed of the off-road vehicle 100 as the vehicle speed information. For example, when the off-road vehicle 100 includes a control device other than the control device 1 and the control device acquires the vehicle speed information of the off-road vehicle 100, the acquisition section 10 may acquire the vehicle speed information of the off-road vehicle 100 from the control device.

Further, in this embodiment, the wheel speed sensor 111 is configured to detect the rotation direction of the wheel 102. Then, the acquisition section 10 acquires the traveling direction of the off-road vehicle 100 as the traveling direction information on the basis of the rotation direction of the wheel 102 detected by the wheel speed sensor 111. Furthermore, the acquisition section 10 may acquire the traveling direction information from a source other than the wheel speed sensor 111. Further, the acquisition section 10 may acquire information for acquiring the traveling direction information from a source other than the wheel speed sensor 111. Further, the acquisition section 10 may acquire a physical quantity other than the traveling direction that can be converted into the traveling direction of the off-road vehicle 100 as the traveling direction information. For example, it is assumed that the off-road vehicle 100 includes a measurement device such as an inertial measurement device that can detect acceleration in the longitudinal direction of the off-road vehicle 100. In such a case, the acquisition section 10 may acquire the traveling direction information on the basis of the acceleration in the longitudinal direction of the off-road vehicle 100.

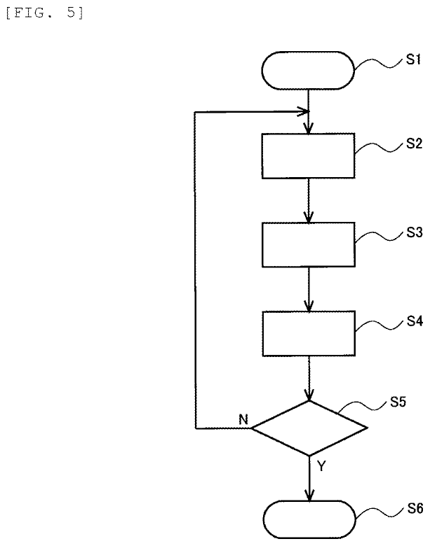

Here, when the acquisition section 10 acquires the traveling direction information of the off-road vehicle 100 on the basis of the rotation direction of the wheel 102 detected by the wheel speed sensor 111, the following effects can be obtained. For example, it is assumed that the off-road vehicle 100 moves forward or backward at a low speed. For example, as will be described later in FIG. 4, the off-road vehicle 100 moves backward at a low speed when the off-road vehicle 100 stops the forward movement on an uphill road surface and temporarily moves backward. In this way, when the off-road vehicle 100 moves forward or backward at a low speed, the longitudinal acceleration of the off-road vehicle 100 has a small value. Therefore, more accurate traveling direction information can be obtained in such a manner that the acquisition section 10 acquires the traveling direction information on the basis of the rotation direction of the wheel 102 detected by the wheel speed sensor 111. Further, plural pieces of information can be acquired by one detection device (wheel speed sensor 111) in such a manner that the acquisition section 10 acquires the vehicle speed information and the traveling direction information of the off-road vehicle 100 on the basis of the detection value of the wheel speed sensor 111. Therefore, the manufacturing cost of the control device 1 can be reduced by decreasing the number of input terminals of the control device 1 in such a manner that the acquisition section 10 acquires the vehicle speed information and the traveling direction information of the off-road vehicle 100 on the basis of the detection value of the wheel speed sensor 111.

The target vehicle speed selection section 20 is a functional section which stores a plurality of target vehicle speeds when executing the hill descent control and selects a suitable target vehicle speed among the plurality of target vehicle speeds. For example, the target vehicle speed selection section 20 includes a storage section 21 as a functional section which stores a plurality of target vehicle speeds. Further, for example, the target vehicle speed selection section 20 includes a selection section 22 as a functional section which selects a suitable target vehicle speed among the plurality of target vehicle speeds. Specifically, the target vehicle speed selection section 20 stores a forward target vehicle speed which is the target vehicle speed when moving the off-road vehicle 100 forward and a backward target vehicle speed which is the target vehicle speed when moving the off-road vehicle 100 backward. Further, the target vehicle speed selection section 20 selects the forward target vehicle speed when the off-road vehicle 100 moves forward and selects the backward target vehicle speed when the off-road vehicle 100 moves backward on the basis of the traveling direction information acquired by the acquisition section 10 as the target vehicle speed of the off-road vehicle 100 when executing the hill descent control. Furthermore, the forward target vehicle speed and the backward target vehicle speed may be fixed values or values that can be changed by the driver or the like.

The execution section 30 is a functional section which controls the braking force generated in the wheels 102 in response to the vehicle speed information acquired by the acquisition section 10 and the target vehicle speed selected by the target vehicle speed selection section 20 and executes the hill descent control. The execution section 30 executes the hill descent control in a state in which the accelerator of the off-road vehicle 100 is not operated. Specifically, the off-road vehicle 100 which is a four-wheeled motor vehicle includes an accelerator pedal 103 as an accelerator operation unit. The execution section 30 controls the braking force generated in the wheels 102 in response to the vehicle speed information acquired by the acquisition section 10 and the target vehicle speed selected by the target vehicle speed selection section 20 while the accelerator pedal 103 is not operated and executes the hill descent control. More specifically, in the hill descent control, the execution section 30 controls the braking device 104 so that the vehicle speed becomes the target vehicle speed when the vehicle speed of the off-road vehicle 100 exceeds the target vehicle speed (or when the vehicle speed is about to exceed the target vehicle speed) while the accelerator pedal 103 is not operated and controls the braking force generated in the wheels 102. The time when the vehicle speed of the off-road vehicle 100 is about to exceed the target vehicle speed is, for example, when the vehicle speed of the off-road vehicle 100 exceeds a specified vehicle speed determined on the basis of the target vehicle speed and lower than the target vehicle speed.

Furthermore, the accelerator pedal 103 is an example of the accelerator operation unit. For example, when the off-road vehicle 100 is a motorcycle or the like, the off-road vehicle 100 may include an accelerator lever as the accelerator operation unit. Further, the configuration for acquiring the accelerator operation information indicating whether or not the accelerator operation unit is operated is not particularly limited. In this embodiment, the off-road vehicle 100 includes an accelerator sensor 112 which detects the operation amount of the accelerator pedal 103. Therefore, the control device 1 acquires the accelerator operation information on the basis of the detection result of the accelerator sensor 112. However, the present invention is not limited thereto and the control device 1 may acquire, for example, the accelerator operation information from a source other than the accelerator sensor 112. Further, the control device 1 may acquire information for acquiring the accelerator operation information from a source other than the accelerator sensor 112. Also, the functional section which acquires the accelerator operation information is not limited. For example, the execution section 30 may acquire the accelerator operation information. Further, for example, the acquisition section 10 may acquire the accelerator operation information and transmit the accelerator operation information acquired by the acquisition section 10 to the execution section 30.

Hereinafter, an example of a traveling situation of the off-road vehicle 100 in which the control device 1 executes the hill descent control will be described with reference to FIGS. 3 and 4.

FIG. 3 is a diagram illustrating an example of the traveling situation of the off-road vehicle 100 according to the embodiment of the present invention.

As shown in FIG. 3, it is assumed that the off-road vehicle 100 moves forward on a downhill road surface 200 as indicated by the white arrow. At this time, when the driver of the off-road vehicle 100 wants to move the off-road vehicle 100 forward slowly, the driver moves the off-road vehicle 100 forward without operating the accelerator. However, the vehicle speed of the off-road vehicle 100 gradually increases due to gravity. At this time, the control device 1 executes the hill descent control.

Specifically, the acquisition section 10 acquires the traveling state information of the off-road vehicle 100 including the vehicle speed information and the traveling direction information. That is, the acquisition section 10 acquires information indicating that the off-road vehicle 100 moves forward as the traveling direction information. The target vehicle speed selection section 20 selects the forward target vehicle speed which is the target vehicle speed when the off-road vehicle 100 moves forward as the target vehicle speed of the off-road vehicle 100 when the hill descent control is executed. Then, the execution section 30 controls the braking force generated in the wheels 102 in response to the vehicle speed information acquired by the acquisition section 10 and the forward target vehicle speed selected by the target vehicle speed selection section 20 while the accelerator of the off-road vehicle 100 is not operated and executes the hill descent control. Specifically, the execution section 30 controls the braking device 104 so that the vehicle speed becomes the forward target vehicle speed when the vehicle speed of the off-road vehicle 100 exceeds the forward target vehicle speed (or when the vehicle speed is about to exceed the forward target vehicle speed) while the accelerator of the off-road vehicle 100 is not operated and controls the braking force generated in the wheels 102.

FIG. 4 is a diagram illustrating another example of the traveling situation of the off-road vehicle 100 according to the embodiment of the present invention.

It is assumed that the off-road vehicle 100 moves forward on the uphill road surface 200. At this time, since the off-road vehicle 100 may travel on the road surface 200 with poor road surface conditions, there is a case in which the off-road vehicle may not climb the road surface 200 when climbing the uphill road surface 200. In such a case, the driver of the off-road vehicle 100 operates the brake to stop the off-road vehicle 100. Then, the driver gradually reduces the braking force generated in the wheels 102 by operating the brake and temporarily moves the off-road vehicle 100 backward as indicated by the white arrow in FIG. 4. Then, the driver attempts to climb the uphill road surface 200 again. When moving the off-road vehicle 100 backward in this way, the off-road vehicle 100 is moved backward with a drive gear selected by the transmission even when the transmission of the off-road vehicle 100 includes a reverse gear in addition to the drive gear.

Here, in the conventional off-road vehicle in which the hill descent control is not executed, when the off-road vehicle stops the forward movement on the uphill road surface 200 and temporarily moves backward, the driver moves the off-road vehicle backward while operating the brake.

Further, in the off-road vehicle in which the conventional control device executes the hill descent control, when the off-road vehicle stops the forward movement on the uphill road surface 200 and temporarily moves backward, the braking force generated in the wheels is controlled so that the target vehicle speed is the same as when moving forward on the downhill road surface 200. However, maneuvering when moving the off-road vehicle backward is more difficult than maneuvering when moving the off-road vehicle forward. Therefore, when the off-road vehicle stops the forward movement on the uphill road surface 200 and temporarily moves backward, the vehicle speed will be too fast for the driver even when the hill descent control is executed at the same target vehicle speed as when moving forward on the downhill road surface 200. Thus, in the off-road vehicle in which the conventional control device executes the hill descent control, when the off-road vehicle stops the forward movement on the uphill road surface 200 and temporarily moves backward, the driver will move the off-road vehicle backward while operating the brake before the hill descent control is executed.

Further, in the conventional control device which executes the hill descent control, when the transmission of the off-road vehicle includes a drive gear and a reverse gear, the target vehicle speed during the hill descent control may differ depending on when the transmission selects the drive gear or the reverse gear. However, as described above, when the off-road vehicle stops the forward movement on the uphill road surface 200 and temporarily moves backward, the off-road vehicle selects the drive gear in the transmission. That is, even in the off-road vehicle equipped with such a conventional control device, when the off-road vehicle stops the forward movement on the uphill road surface 200 and temporarily moves backward, the braking force generated in the wheels is controlled so that the target vehicle speed is the same as when moving forward on the downhill road surface 200. Therefore, even in the off-road vehicle equipped with such a conventional control device, when the off-road vehicle stops the forward movement on the uphill road surface 200 and temporarily moves backward, the driver will move the off-road vehicle backward while operating the brake before the hill descent control is executed.

In this way, in the conventional control device which executes the hill descent control, when the off-road vehicle stops the forward movement on the uphill road surface 200 and temporarily moves backward, the driver needs to concentrate on both steering and braking operations. Therefore, in the conventional control device which executes the hill descent control, when the off-road vehicle stops the forward movement on the uphill road surface 200 and temporarily moves backward, the driver's concentration on the steering operation is reduced.

On the other hand, in the control device 1 according to this embodiment, when the off-road vehicle 100 stops the forward movement on the uphill road surface 200 and temporarily moves backward, the hill descent control is executed as below. Specifically, the acquisition section 10 acquires the traveling state information of the off-road vehicle 100 including the vehicle speed information and the traveling direction information. That is, the acquisition section 10 acquires information indicating that the off-road vehicle 100 moves backward as the traveling direction information. The target vehicle speed selection section 20 selects the backward target vehicle speed which is the target vehicle speed when the off-road vehicle 100 moves backward as the target vehicle speed of the off-road vehicle 100 when the hill descent control is executed. Then, the execution section 30 controls the braking force generated in the wheels 102 in response to the vehicle speed information acquired by the acquisition section 10 and the backward target vehicle speed selected by the target vehicle speed selection section 20 while the accelerator of the off-road vehicle 100 is not operated and executes the hill descent control. Specifically, the execution section 30 controls the braking device 104 so that the vehicle speed becomes the backward target vehicle speed when the vehicle speed of the off-road vehicle 100 exceeds the backward target vehicle speed (or when the vehicle speed is about to exceed the backward target vehicle speed) while the accelerator of the off-road vehicle 100 is not operated and controls the braking force generated in the wheels 102.

In this way, in the control device 1 according to this embodiment, when the off-road vehicle 100 stops the forward movement on the uphill road surface 200 and temporarily moves backward, the hill descent control is executed by using the backward target vehicle speed different from the forward target vehicle speed when moving forward on the downhill road surface 200. Thus, since the backward target vehicle speed is set to a value smaller than the forward target vehicle speed, the control device 1 according to this embodiment can decrease the number of situations in which the driver has to operate the brake compared to the conventional control device when the off-road vehicle 100 stops the forward movement on the uphill road surface 200 and temporarily moves backward. Therefore, the control device 1 according to this embodiment allows the driver to concentrate more on the steering operation than before when the off-road vehicle 100 stops the forward movement on the uphill road surface 200 and temporarily moves backward.

<Control Method when Control Device Executes Hill Descent Control>

FIG. 5 is a flowchart showing a control method when the control device according to the embodiment of the present invention executes the hill descent control.

When the control start condition is met, the control device 1 starts the control shown in FIG. 5 in step S1. The control start condition is, for example, when the engine of the off-road vehicle 100 is started. Further, for example, when the off-road vehicle 100 is equipped with a selection unit such as a switch for selecting a mode for executing the hill descent control and a mode for not executing the hill descent control, the control start condition is when the mode for executing the hill descent control is selected.

Step S2 after step S1 is an acquisition step. In step S2, the acquisition section 10 of the control device 1 acquires the traveling state information of the off-road vehicle 100 including the vehicle speed information and the traveling direction information. Step S3 after step S2 is a target vehicle speed selection step. In step S3, the target vehicle speed selection section 20 of the control device 1 selects the forward target vehicle speed when moving the off-road vehicle 100 forward and selects the backward target vehicle speed when moving the off-road vehicle 100 backward on the basis of the traveling direction information acquired in the acquisition step of step S2 as the target vehicle speed of the off-road vehicle 100 when executing the hill descent control.

Step S4 after step S3 is an execution step. In step S4, the execution section 30 of the control device 1 controls the braking force generated in the wheels 102 in response to the vehicle speed information acquired in the acquisition step of step S2 and the target vehicle speed selected in the target vehicle speed selection step of step S3 while the accelerator of the off-road vehicle 100 is not operated and executes the hill descent control. For example, the execution section 30 executes the hill descent control when the vehicle speed of the off-road vehicle 100 exceeds the target vehicle speed while the accelerator of the off-road vehicle 100 is not operated. In other words, the execution section 30 is in a standby state without executing the hill descent control when the accelerator of the off-road vehicle 100 is operated. Further, the execution section 30 is in the standby state without executing the hill descent control when the vehicle speed of the off-road vehicle 100 does not exceed the target vehicle speed. Further, for example, the execution section 30 executes the hill descent control when the vehicle speed of the off-road vehicle 100 is about to exceed the target vehicle speed while the accelerator of the off-road vehicle 100 is not operated. The time when the vehicle speed of the off-road vehicle 100 is about to exceed the target vehicle speed is, for example, when the vehicle speed of the off-road vehicle 100 exceeds a specified vehicle speed determined on the basis of the target vehicle speed and lower than the target vehicle speed. In other words, the execution section 30 is in the standby state without executing the hill descent control when the vehicle speed of the off-road vehicle 100 does not exceed the specified vehicle speed.

### <Effect of Control Device>

The effect of the control device according to this embodiment will be described.

The control device 1 according to this embodiment is a control device that controls the braking force generated in the wheels 102 of the off-road vehicle 100 and executes the hill descent control. The control device 1 includes the acquisition section 10, the target vehicle speed selection section 20, and the execution section 30. The acquisition section 10 is configured to acquire the traveling state information of the off-road vehicle 100 including the vehicle speed information and the traveling direction information. The target vehicle speed selection section 20 is configured to store the forward target vehicle speed which is the target vehicle speed when moving the off-road vehicle 100 forward and the backward target vehicle speed which is the target vehicle speed when moving the off-road vehicle 100 backward and select the forward target vehicle speed when moving the off-road vehicle 100 forward and the backward target vehicle speed when moving the off-road vehicle 100 backward as the target vehicle speed of the off-road vehicle 100 on the basis of the traveling direction information acquired by the acquisition section 10. The execution section 30 is configured to control the braking force generated in the wheels 102 in response to the vehicle speed information acquired by the acquisition section 10 and the target vehicle speed selected by the target vehicle speed selection section 20 while the accelerator of the off-road vehicle 100 is not operated and execute the hill descent control.

As described above, the control device 1 with such a configuration can decrease the number of situations in which the driver has to operate the brake compared to the conventional control device when the off-road vehicle 100 stops the forward movement on the uphill road surface 200 and temporarily moves backward. Therefore, the control device 1 with such a configuration allows the driver to concentrate more on the steering operation than before when the off-road vehicle 100 stops the forward movement on the uphill road surface 200 and temporarily moves backward.

### Modified Example

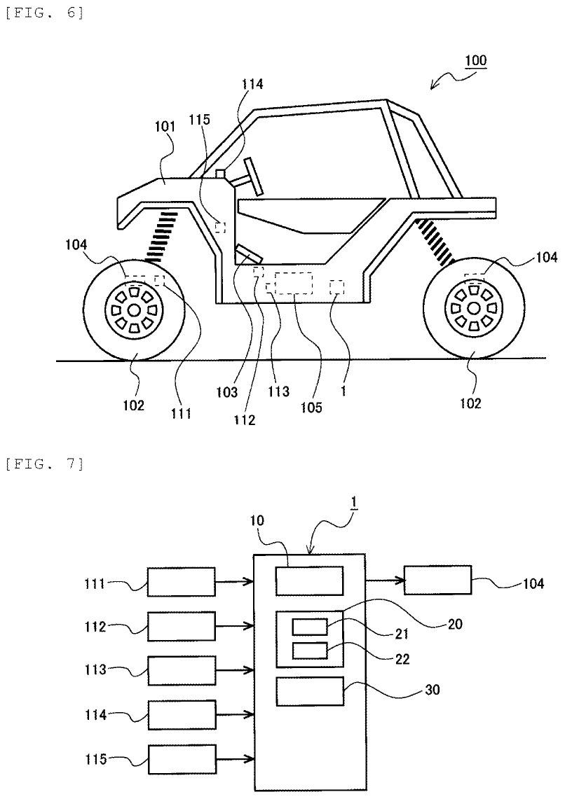

FIG. 6 is a side view of an off-road vehicle equipped with a modified example of the control device according to the embodiment of the present invention. FIG. 7 is a block diagram showing a modified example of the control device according to the embodiment of the present invention.

When a transmission 105 of the off-road vehicle 100 includes a drive gear and a reverse gear, the control device 1 may be configured as follows. The traveling state information acquired by the acquisition section 10 includes gear information which is information of the gear selected by the transmission 105 of the off-road vehicle 100. In this embodiment, the off-road vehicle 100 includes a gear position detection device 113 which detects the gear selected by the transmission 105. Then, the acquisition section 10 acquires the gear information on the basis of the detection result of the gear position detection device 113. Further, the target vehicle speed selection section 20 stores the target vehicle speed at the drive gear and the target vehicle speed at the reverse gear as the backward target vehicle speed. Then, when selecting the backward target vehicle speed as the target vehicle speed of the off-road vehicle 100, the target vehicle speed selection section 20 is configured to select the target vehicle speed at the drive gear when the drive gear is selected by the transmission 105 and select the target vehicle speed at the reverse gear when the reverse gear is selected by the transmission 105 on the basis of the gear information acquired by the acquisition section 10.

As described above, the control device 1 according to this embodiment can execute the hill descent control when the off-road vehicle 100 moves backward. Therefore, there is a case in which the control device 1 executes the hill descent control when the off-road vehicle 100 normally moves backward in addition to the traveling situation shown in FIG. 4 in which the off-road vehicle 100 stops the forward movement on the uphill road surface 200 and temporarily moves backward. The normal backward movement of the off-road vehicle 100 is a traveling situation in which the off-road vehicle 100 moves backward to a desired location with the reverse gear selected by the transmission 105. Specifically, it is assumed that the off-road vehicle 100 travels on the road surface 200 that descends from the front to the rear of the off-road vehicle 100 when the off-road vehicle normally moves backward. In such a case, when the driver of the off-road vehicle 100 wants to slowly move the off-road vehicle 100 backward, the driver moves the off-road vehicle 100 backward without operating the accelerator. However, the vehicle speed of the off-road vehicle 100 gradually increases due to gravity. At this time, the control device 1 executes the hill descent control.

Here, the preferred vehicle speed of the off-road vehicle 100 for the driver may differ between when the off-road vehicle 100 stops the forward movement on the uphill road surface 200 and temporarily moves backward and when the off-road vehicle 100 normally moves backward. At this time, the vehicle speed of the off-road vehicle 100 during the hill descent control can be different when the off-road vehicle 100 stops the forward movement on the uphill road surface 200 and temporarily moves backward and when the off-road vehicle 100 normally moves backward by selectively using the target vehicle speed at the drive gear and the target vehicle speed at the reverse gear as the backward target vehicle speed. Therefore, the convenience of the control device 1 is improved by selectively using the target vehicle speed at the drive gear and the target vehicle speed at the reverse gear as the backward target vehicle speed.

Furthermore, the acquisition section 10 may acquire the gear information from a source other than the gear position detection device 113. Further, the acquisition section 10 may acquire information for acquiring the gear information from a source other than the gear position detection device 113. For example, when the off-road vehicle 100 includes a control device other than the control device 1 that acquires the gear information of the off-road vehicle 100, the acquisition section 10 may acquire the gear information of the off-road vehicle 100 from the control device.

Further, when the target vehicle speed selection section 20 stores the target vehicle speed at the drive gear as the backward target vehicle speed, the target vehicle speed selection section 20 may be configured as follows. For example, the target vehicle speed selection section 20 stores a plurality of target vehicle speeds at the drive gear. Then, the target vehicle speed selection section 20 is configured to select one of the plurality of target vehicle speeds at the drive gear when selecting the target vehicle speed at the drive gear as the target vehicle speed of the off-road vehicle 100. In the traveling situation in which the off-road vehicle 100 stops the forward movement on the uphill road surface 200 and temporarily moves backward, the target vehicle speed selection section 20 selects the target vehicle speed at the drive gear during the hill descent control. Depending on various factors, it may be preferable to vary the vehicle speed of the off-road vehicle 100 during the hill descent control. Therefore, since the target vehicle speed selection section 20 is configured to select one of the plurality of target vehicle speeds at the drive gear, the convenience of the control device 1 is further improved.

For example, the target vehicle speed selection section 20 may select one of the plurality of target vehicle speeds at the drive gear on the basis of the traveling state information acquired by the acquisition section 10 when selecting the target vehicle speed at the drive gear as the target vehicle speed of the off-road vehicle 100.

Specifically, for example, the transmission 105 of the off-road vehicle 100 may include drive gears in multiple stages (low gear, second gear, third gear, top gear, and the like). In such a case, the gear information may include selection stage information indicating the drive gear selected by the transmission 105 among the drive gears in multiple stages. For example, the acquisition section 10 acquires the gear information including the selection stage information on the basis of the detection result of the gear position detection device 113. Furthermore, as described above, the gear information acquiring configuration is not particularly limited. Then, the target vehicle speed selection section 20 may select one of the plurality of target vehicle speeds at the drive gear on the basis of the selection stage information acquired by the acquisition section 10.

As described above, in the traveling situation in which the off-road vehicle 100 stops the forward movement on the uphill road surface 200 and temporarily moves backward, the target vehicle speed selection section 20 selects the target vehicle speed at the drive gear. At this time, the drive gear selected by the transmission 105 when moving forward on the uphill road surface 200 may differ depending on the road surface condition of the road surface 200, the obliquity of the road surface 200, the driver's skill, and the like. That is, the drive gear selected by the transmission 105 when the off-road vehicle 100 stops the forward movement on the uphill road surface 200 and temporarily moves backward may differ depending on the road surface condition of the road surface 200, the obliquity of the road surface 200, the driver's skill, and the like. Further, the preferred vehicle speed of the off-road vehicle 100 may differ when the off-road vehicle 100 stops the forward movement on the uphill road surface 200 and temporarily moves backward depending on the road surface condition of the road surface 200, the obliquity of the road surface 200, the driver's skill, and the like. Therefore, since the target vehicle speed selection section 20 selects one of the plurality of target vehicle speeds at the drive gear on the basis of the selection stage information acquired by the acquisition section 10, the convenience of the control device 1 is further improved.

Further, for example, some conventional vehicles are equipped with a traveling mode selection unit capable of selecting a plurality of traveling modes. The traveling mode selection unit is configured as, for example, a mechanical switch, a capacitive switch provided on a touch panel, or the like. When the off-road vehicle 100 includes such a traveling mode selection unit 114, the traveling state information may include the traveling mode information indicating the traveling mode selected among the plurality of traveling modes. For example, the acquisition section 10 acquires the traveling mode information on the basis of the detection result of the traveling mode selection unit 114. Furthermore, the acquisition section 10 may acquire the traveling mode information from a source other than the traveling mode selection unit 114, such as a control device installed in the off-road vehicle 100 other than the control device 1. Then, the target vehicle speed selection section 20 may select one of the plurality of target vehicle speeds at the drive gear on the basis of the traveling mode information acquired by the acquisition section 10. Accordingly, when the off-road vehicle 100 stops the forward movement on the uphill road surface 200 and temporarily moves backward, the vehicle speed of the off-road vehicle 100 can be controlled to the vehicle speed suitable for the traveling mode desired by the driver according to the hill descent control. Therefore, since the target vehicle speed selection section 20 selects one of the plurality of target vehicle speeds at the drive gear on the basis of the traveling mode information acquired by the acquisition section 10, the convenience of the control device 1 is further improved.

Further, when the off-road vehicle 100 includes a detection device for detecting the longitudinal acceleration of the off-road vehicle 100, the execution section 30 may control the braking force generated in the wheels 102 in response to the longitudinal acceleration of the off-road vehicle 100 when executing the hill descent control. In this embodiment, the off-road vehicle 100 includes an inertial measurement device 115 which detects the longitudinal acceleration of the off-road vehicle 100. Therefore, the execution section 30 controls the braking force generated in the wheels 102 on the basis of the longitudinal acceleration of the off-road vehicle 100 detected by the inertial measurement device 115. Furthermore, the execution section 30 may acquire the longitudinal acceleration of the off-road vehicle 100 from a source other than the inertial measurement device 115. Further, when the execution section 30 acquires the longitudinal acceleration of the off-road vehicle 100, the execution section 30 may directly acquire the acceleration or the acceleration acquired by the acquisition section 10 may be transmitted to the execution section 30. Accordingly, it is possible to suppress sudden deceleration of the off-road vehicle 100 and improve the comfort of the driver of the off-road vehicle 100.

Although an example of the control device according to the present invention has been described above in the embodiment, the control device according to the present invention is not limited to the description of the embodiment. For example, in the control device according to the present invention, only a part of the description of the embodiment may be implemented. Further, the backward target vehicle speed may be set to a larger value than the forward target vehicle speed depending on the situation (for example, road surface conditions, surrounding conditions, and the like).

### REFERENCE SIGNS LIST

1: Control device
10: Acquisition section
20: Target vehicle speed selection section
21: Storage section
22: Selection section
30: Execution section
100: Off-road vehicle
101: Vehicle body
102: Wheel
103: Accelerator pedal
104: Braking device
105: Transmission
111: Wheel speed sensor
112: Accelerator sensor
113: Gear position detection device
114: Traveling mode selection unit
115: Inertial measurement device
200: Road surface

1. A control device (1) for controlling a braking force generated in a wheel (102) of an off-road vehicle (100) and executing hill descent control, the control device (1) configured to:
acquire traveling state information of the off-road vehicle (100) including vehicle speed information and traveling direction information;
store a forward target vehicle speed which is a target vehicle speed when moving the off-road vehicle (100) forward and a backward target vehicle speed which is a target vehicle speed when moving the off-road vehicle (100) backward and selects the forward target vehicle speed when moving the off-road vehicle (100) forward and the backward target vehicle speed when moving the off-road vehicle (100) backward as the target vehicle speed of the off-road vehicle (100) based on the traveling direction information acquired by the control device; and
control the braking force in response to the vehicle speed information acquired by the control device and the target vehicle speed selected by the control device while an accelerator of the off-road vehicle (100) is not operated and executes the hill descent control.

2. The control device (1) according to claim 1,
wherein the traveling state information includes gear information which is information of a gear selected by a transmission (105) of the off-road vehicle (100), and
wherein the control device is configured to store a target vehicle speed at a drive gear and a target vehicle speed at a reverse gear as the backward target vehicle speed and select the target vehicle speed at the drive gear when the drive gear is selected by the transmission (105) and the target vehicle speed at the reverse gear when the reverse gear is selected by the transmission (105) based on the gear information acquired by the control device when selecting the backward target vehicle speed as the target vehicle speed of the off-road vehicle (100).

3. The control device (1) according to claim 2,
wherein the control device is configured to store a plurality of target vehicle speeds at the drive gear and select one of the plurality of target vehicle speeds at the drive gear when selecting the target vehicle speed at the drive gear as the target vehicle speed of the off-road vehicle (100).

4. The control device (1) according to claim 3,
wherein the control device is configured to select one of the plurality of target vehicle speeds at the drive gear based on the traveling state information acquired by the control device when selecting the target vehicle speed at the drive gear as the target vehicle speed of the off-road vehicle (100).

5. The control device (1) according to claim 4,
wherein the transmission (105) includes the drive gears in multiple stages,
wherein the gear information includes selection stage information indicating the drive gear selected by the transmission (105) in the drive gears in multiple stages, and
wherein the control device is configured to select one of the plurality of target vehicle speeds at the drive gear based on the selection stage information acquired by the control device.

6. The control device (1) according to claim 4,
wherein the traveling state information includes traveling mode information indicating a traveling mode selected among a plurality of traveling modes, and
wherein the control device is configured to select one of the plurality of target vehicle speeds at the drive gear based on the traveling mode information acquired by the control device.

7. The control device (1) according to claim 1,
wherein the control device is configured to acquire the traveling direction information based on a rotation direction of the wheel (102).

8. The control device (1) according to claim 7,
wherein the control device is configured to acquire the vehicle speed information base on a rotation speed of the wheel (102).

9. The control device (1) according to claim 1,
wherein the control device is further configured to control the braking force in response to a longitudinal acceleration of the off-road vehicle (100).

10. An off-road vehicle (100) comprising:
the control device (1) according to claim 1.

11. A control method of controlling a braking force generated in a wheel (102) of an off-road vehicle (100) and executing hill descent control, the control method comprising:
an acquisition step (S2) of acquiring traveling state information of the off-road vehicle (100) including vehicle speed information and traveling direction information;
a target vehicle speed selection step (S3) of selecting a forward target vehicle speed when moving the off-road vehicle (100) forward and a backward target vehicle speed when moving the off-road vehicle (100) backward as the target vehicle speed of the off-road vehicle (100) based on the traveling direction information acquired by the acquisition step (S2); and
an execution step (S4) of controlling the braking force in response to the vehicle speed information acquired by the acquisition step (S2) and the target vehicle speed selected by the target vehicle speed selection step (S3) while an accelerator of the off-road vehicle (100) is not operated and executing the hill descent control.
